(19) United States
(12) Patent Application Publication
(10) Pub. No.: US 2022/0006957 A1
(43) Pub. Date: Jan. 6, 2022

(54) IMAGING APPARATUS FOR SHAKE CORRECTION OF CAPTURED IMAGE, METHOD, AND STORAGE MEDIUM

(71) Applicant: CANON KABUSHIKI KAISHA, Tokyo (JP)

(72) Inventor: Satoshi Ashitani, Chiba (JP)

(21) Appl. No.: 17/362,200

(22) Filed: Jun. 29, 2021

(30) Foreign Application Priority Data
Jul. 2, 2020 (JP) 2020-115057

(51) Int. Cl. H04N 5/232

(52) U.S. Cl. CPC H04N 5/23261; H04N 5/23296

(57) ABSTRACT

An imaging apparatus includes an imaging unit, a zoom driving unit, an extraction unit, a shake detection unit, a shake correcting unit, and a control unit configured. The imaging unit is configured to capture an image formed by an imaging optical system. The zoom driving unit is configured to change an angle-of-view of the imaging optical system. The extraction unit is configured to extract an area in which a motion vector can be detected in the captured image. The shake detection unit is configured to detect an amount of shake of the image based on the motion vector in the extracted area. The shake correcting unit configured to correct shake of the image based on the detected amount of shake. The control unit is configured to control the zoom driving unit to prevent the extracted area from deviating from a field of view of the imaging optical system.

### BACKGROUND

### Technical Field

One disclosed aspect of the embodiments relates to an imaging apparatus, a method, and a storage medium.

### Description of the Related Art

A technique of controlling an optical image stabilizer so that an image of an object falls within a detection area has been conventionally known (Japanese Patent Application Laid-Open No. 2017-106947).

### SUMMARY

According to an aspect of the embodiments, an imaging apparatus includes an imaging unit, a zoom driving unit, an extraction unit, a shake detection unit, a shake correcting unit, and a control unit. The imaging unit is configured to capture an image formed by an imaging optical system. The zoom driving unit is configured to change an angle-of-view of the imaging optical system. The extraction unit is configured to extract an area in which a motion vector can be detected in the image captured by the imaging unit. The shake detection unit is configured to detect an amount of shake of the image based on the motion vector in the area extracted by the extraction unit. The shake correcting unit is configured to correct the shake of the image based on the amount of shake detected by the shake detection unit. The control unit is configured to control the zoom driving unit to prevent the area extracted by the extraction unit from deviating from a field of view of the imaging optical system.

Further features of the disclosure will become apparent from the following description of exemplary embodiments with reference to the attached drawings.

### BRIEF DESCRIPTION OF THE DRAWINGS

FIG. 1 is a functional block diagram illustrating a network camera according to a first exemplary embodiment.

FIGS. 2A and 2B are diagrams illustrating a mechanical configuration of the network camera according to the first exemplary embodiment.

FIG. 3 is a diagram illustrating motion of a camera head during image stabilizing control according to the first exemplary embodiment.

FIG. 4 is a flowchart illustrating image stabilizing control processing according to the first exemplary embodiment.

FIG. 5 is a diagram illustrating an example of a relationship between a shake detection area and a designated angle-of-view in a captured image according to the first exemplary embodiment.

FIG. 6 is a flowchart illustrating zoom control processing according to the first exemplary embodiment.

FIG. 7 is a flowchart illustrating zoom control processing utilizing digital zoom according to the first exemplary embodiment.

FIG. 8 is a diagram illustrating an example of a relationship between a shake detection area and a designated angle-of-view in a captured image according to a second exemplary embodiment.

FIG. 9 is a diagram illustrating an example of a relationship between a shake detection area and a designated angle-of-view in a captured image according to a third exemplary embodiment.

FIG. 10 is a functional block diagram of a network camera according to a fourth exemplary embodiment.

### DESCRIPTION OF THE EMBODIMENTS

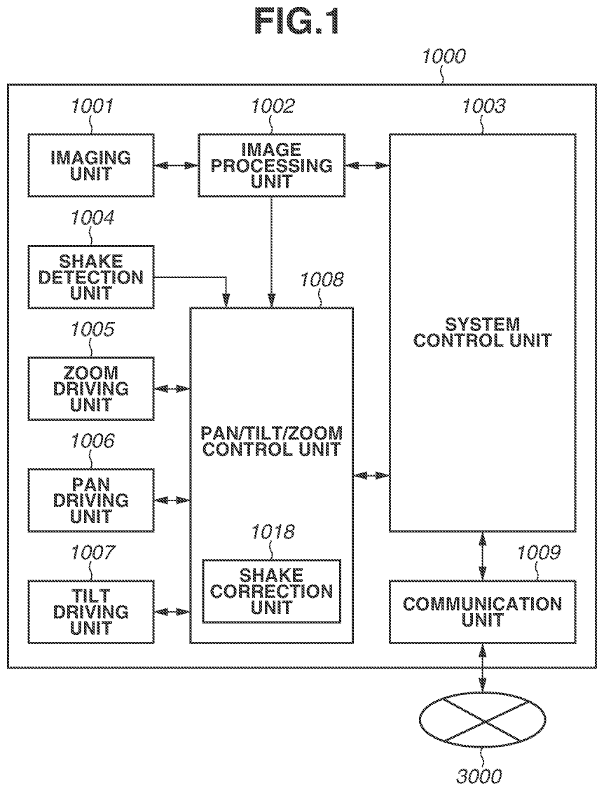

FIG. 1 is a functional block diagram illustrating a network camera 1000 according to a first exemplary embodiment. A network camera (e.g., imaging apparatus) 1000 is connected to a client apparatus (e.g., information processing apparatus), which is not illustrated, via a network 3000 so as to be communicable with each other.

The network camera 1000 includes an imaging unit 1001, an image processing unit 1002, a system control unit 1003, a shake detection unit 1004, a zoom driving unit 1005, a pan driving unit 1006, a tilt driving unit 1007, a pan/tilt/zoom control unit 1008, and a communication unit 1009. The term “unit” here may refer to a subsystem, an apparatus, a device, a component, or a function or module executed by a program.

A description is now given of a configuration and function of each unit of the network camera 1000 with reference to FIG. 1.

The imaging unit 1001 is composed of a lens (e.g., imaging optical system), an image sensor, and a control group of the image sensor. The imaging unit 1001 captures an image of a subject, and converts the image to an electric signal.

The image processing unit 1002 performs predetermined development processing and compression coding processing on signals obtained by photoelectrically converting an image captured by the imaging unit 1001, generates image data, and transmits the image data to the system control unit 1003. In addition, the image processing unit 1002 performs processing of analyzing a captured image and detecting shake of the image using a motion vector. The shake may be caused by movement or vibration of the image. Information of the shake is transmitted to the pan/tilt/zoom control unit 1008, and used for image stabilizing control, which will be described below.

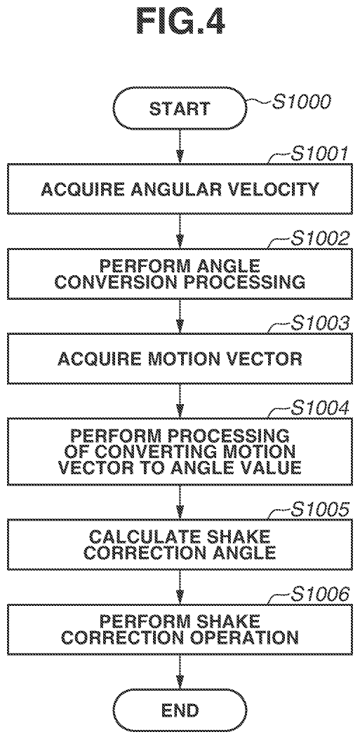

The system control unit 1003 distributes the generated image data to the client apparatus via the communication unit 1009. In general, the system control unit 1003 may include a processor (e.g., a programmable device, a central processing unit) and a memory device that stores instructions or program, The instructions, when executed by the processor, cause the processor to perform operations as functional units described in the following. The communication unit 1009 receives (accepts) a camera control command transmitted from the client apparatus, and transmits the camera control command to the system control unit 1003. In addition, the communication unit 1009 transmits a response to the camera control command to the client apparatus. The system control unit 1003 analyzes the transmitted camera control command, and executes processing corresponding to the command For example, the system control unit 1003 gives instructions for making settings of image quality to the image processing unit 1002, and gives instructions for pan/tilt/zoom operations to the pan/tilt/zoom control unit 1008. The image processing unit 1002 performs image processing based on the transmitted instructions. The pan/tilt/zoom control unit 1008 performs control of the zoom driving unit 1005, the pan driving unit 1006, and the tilt driving unit 1007 based on the transmitted instruction. The pan/tilt/zoom control unit 1008 may also include a processor that executes instructions or a program stored in a memory to perform various control functions for the pan/tilt/zoom. In particular, the pan/tilt/zoom control unit 1008 may include a shake correction unit 1018 that performs shake correction as described in FIG. 4. The shake correction corrects the shake, movement, or vibration of the image.

The shake detection unit 1004 is composed of a gyro sensor and the like, and detects angular velocities in pan and tilt directions of the imaging unit 1001. The shake detection unit 1004 transmits to the pan/tilt/zoom control unit 1008 information of the detected angular velocities to be used for image stabilizing control, which will be described below.

The zoom driving unit 1005 is composed of a mechanical driving system that performs a zoom operation, a motor serving as a driving source of the mechanical driving system, an encoder that detects an angle of the zoom driving unit 1005, and the like. The pan driving unit 1006 is composed of a mechanical driving system that performs a pan operation, a motor serving as a driving source of the mechanical driving system, a sensor that detects an angle of the pan driving unit 1006, and the like. In addition, the tilt driving unit 1007 is composed of a mechanical driving system that performs a tilt operation, a motor serving as a driving source of the mechanical driving system, a sensor that detects an angle of the tilt driving unit 1007, and the like. The operations of the zoom driving unit 1005, the pan driving unit 1006, and the tilt driving unit 1007 are controlled by the pan/tilt/zoom control unit 1008.

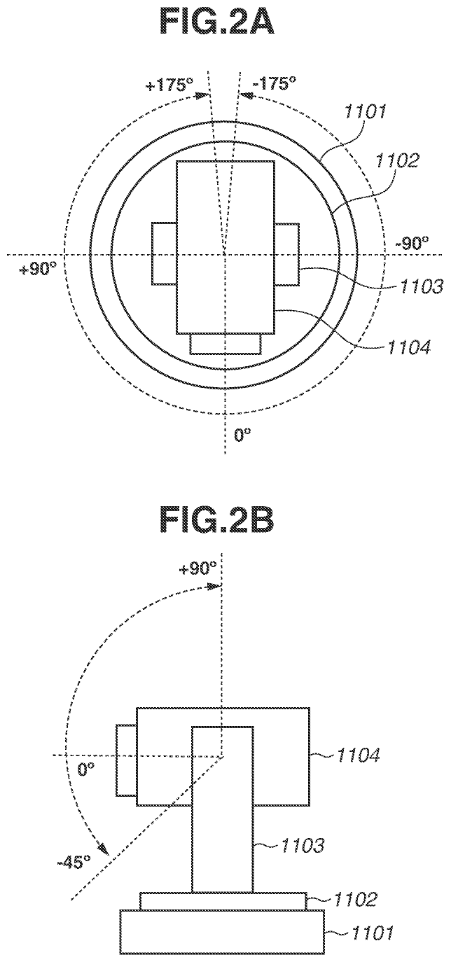

FIGS. 2A and 2B are mechanical configuration diagrams of the network camera 1000 capable of performing pan/tilt operations according to the present exemplary embodiment. FIG. 2A is a top view, and FIG. 2B is a side view. FIGS. 2A and 2B illustrate a bottom case 1101, a turntable 1102, a camera head supporting column 1103, and a camera head 1104.

A description will be given of a mechanical configuration of the pan driving unit 1006 and the tilt driving unit 1007 with reference to FIGS. 2A and 2B. In FIGS. 2A and 2B, the pan driving unit 1006 is composed of the bottom case 1101 and the turntable 1102, and the turntable 1102 rotates in a horizontal direction. The pan driving unit 1006 of the network camera 1000 according to the present exemplary embodiment can rotate in a horizontal direction from −175 degrees to +175 degrees.

The tilt driving unit 1007 is composed of the camera head supporting column 1103 arranged on the turntable 1102 and the camera head 1104, and the camera head 1104 rotates in a vertical direction. The tilt driving unit 1007 of the network camera 1000 according to the present exemplary embodiment can rotate, assuming that the horizontal direction is equal to zero degrees, from −45 degrees, which is in an obliquely lower direction, to 90 degrees, which is in a direction directly above the network camera 1000.

In this manner, the network camera 1000 according to the present exemplary embodiment can capture an image while changing an image-capturing direction by causing the camera head to rotate in the horizontal direction and the vertical direction. In addition, the network camera 1000 is configured to drive the camera head to cancel the shake detected by the shake detection unit using the pan/tilt driving units, and thereby capture an image with the reduced shake.

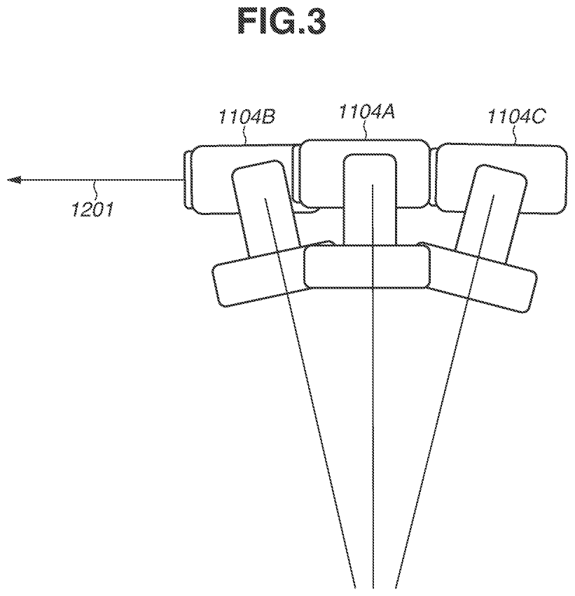

FIG. 3 is a diagram illustrating motion of the camera head 1104 during pan/tilt (PT) image stabilizing control. FIG. 3 illustrates a camera head 1104A in a state without shake, a camera head 1104B in a state of being tilted forward caused by shake, a camera head 1104C in a state of being tilted backward caused by shake, and an image-capturing direction 1201.

In FIG. 3, the camera head 1104 is oriented in the horizontal direction in the state without shake as indicated by the camera head 1104A, and the network camera 1000 captures an image in the image-capturing direction 1201. In a case of being tilted backward from this state due to shake of a mounting surface as indicated by the camera head 1104C, the network camera 1000 maintains the image-capturing direction 1201 by controlling a tilt angle downward. In a case of being tilted forward due to shake of the mounting surface as indicated by the camera head 1104B, the network camera 1000 maintains the image-capturing direction 1201 by controlling the tilt angle upward. In this manner, in the PT image stabilizing control, the network camera 1000 detects the tilting of the camera head due to shake of the mounting surface and controls the PT driving units to maintain the image-capturing direction, and thereby captures an image with the reduced shake.

FIG. 4 is a flowchart illustrating PT image stabilizing control processing S1000. When the network camera 1000 starts to capture an image, the pan/tilt/zoom control unit 1008 starts to perform the processing of S1000.

In step S1001, the pan/tilt/zoom control unit 1008 acquires from the shake detection unit 1004 an angular velocity in the pan direction and an angular velocity in the tilt direction.

In step S1002, the pan/tilt/zoom control unit 1008 integrates the acquired angular velocity in the pan direction to calculate a pan angle value. In addition, the pan/tilt/zoom control unit 1008 integrates the acquired angular velocity in the tilt direction over time to calculate a tilt angle value.

In step S1003, the image processing unit 1002 calculates a motion vector. The image processing unit 1002 calculates the motion vector by using, for example, block matching. In the block matching, the image processing unit 1002 divides the entire image into, for example, blocks each having 16 pixels×16 pixels. The image processing unit 1002 slides one of divided blocks in the previous frame, and searches for the most matched block. To make determination of the matching, the image processing unit 1002 acquires an absolute value of a difference of pixels in luminance between the previous frame and the current frame to use a sum of the absolute values as an evaluation value, and searches for a block having the smallest evaluation value. The image processing unit 1002 obtains, as a motion vector, an amount of movement of a target block from the position of the most matched area in the previous frame and the position in the current frame. The image processing unit 1002 searches other blocks in a similar manner to obtain motion vectors with respect to all the blocks. The image processing unit 1002 averages the motion vectors thus calculated for the respective blocks to obtain a motion vector for the entire image. The pan/tilt/zoom control unit 1008 acquires the motion vector obtained by the image processing unit 1002.

In step S1004, the pan/tilt/zoom control unit 1008 separates the motion vector into a vector in the pan (horizontal) direction and a vector in the tilt (vertical) direction, and converts the vectors into angle values to calculate a pan angle value and a tilt angle value.

In step S1005, the pan/tilt/zoom control unit 1008 calculates a correction angle (correction amount) to be in more pan direction than the calculated pan angle value. In addition, the pan/tilt/zoom control unit 1008 calculates a correction angle (correction amount) to be in more tilt direction than the calculated tilt angle value. The pan/tilt/zoom control unit 1008 calculates each correction angle to cancel an angle caused by shake. For example, in a case of the tilt angle value being 0.1 degrees, assume that the correction angle is −0.1 degrees. The present exemplary embodiment utilizes more effective information out of information of shake detected by the gyro sensor and information of shake detected by the motion vector depending on characteristics of these pieces of information. The present exemplary embodiment uses these pieces of information in different cases. For example, a method of detecting shake using the motion vector is mainly utilized with respect to shake at a low frequency, while a method of detecting shake using the gyro sensor is mainly utilized with respect to shake at a high frequency.

In step S1006, the pan/tilt/zoom control unit 1008 performs shake correction by giving driving instructions to the pan driving unit 1006 and the tilt driving unit 1007 corresponding to the calculated correction angle in the pan direction and the calculated correction angle in the tilt direction, respectively, and ends the processing.

As described above, in the PT prevention control, the network camera 1000 controls the pan/tilt driving units to cancel shake in accordance with shake detected in the pan direction and shake detected in the tilt direction, respectively, and reduces the shake.

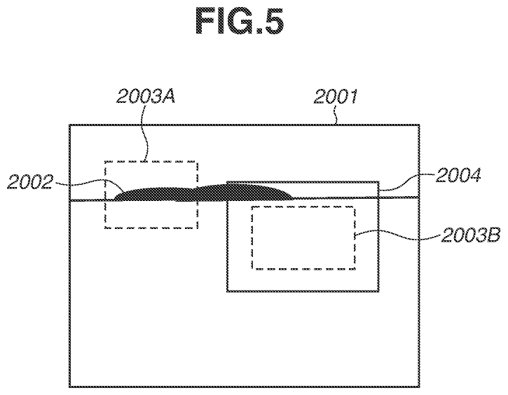

FIG. 5 is a diagram illustrating an example of a captured image in a case where the network camera 1000 according to the present exemplary embodiment is installed on a ship, and an image of sea direction is captured. FIG. 5 illustrates an image-capturing angle-of-view 2001 at a wide-angle end, a shake detection area (motion vector detectable area) 2002, a PTZ (pan/tilt/zoom) designated angle-of-view (imaging range) 2003A and 2003B, and a shake detectable angle-of-view 2004.

As illustrated in FIG. 5, the image is captured with the image-capturing angle-of-view 2001 at the wide-angle end to include the shadow of a mountain on the upper portion of the image. Since a subject that is fixed and that has feature points such as edges is included in the shake detection area 2002, shake can be detected using the motion vector with respect to this area. Since the other areas, such as the sky and the sea, are areas having few feature points, the shake cannot be detected correctly with respect to the other areas. With the image-capturing angle-of-view 2001 at the wide-angle end, the network camera 1000 detects shake using the motion vector as described above utilizing the shake detection area 2002, and performs image stabilizing control based on the detected shake.

In a case where the angle-of-view is changed from this state by the PTZ operation, for example, in a case where the angle-of-view is changed to the designated angle-of-view 2003A, the motion vector detectable area (shake detection area) 2002 is within the image-capturing angle-of-view, and thus the shake can be detected. This brings the network camera 1000 into a state of being able to effectively perform the image stabilizing control. On the other hand, in a case where the angle-of-view is changed to the designated angle-of-view 2003B, the shake detectable area 2002 is outside the image-capturing angle-of-view, and thus the shake cannot be detected. As a result, the network camera 1000 cannot effectively perform the image stabilizing control, thereby producing an image with the shake remained. To address this, instead of optically zooming in/out to the designated angle-of-view 2003B, the network camera 1000 restricts optical zooming to the designated angle-of-view 2004 including the shake detectable area 2002 on a wider-angle side than the designated angle-of-view 2003B, and can thereby detect shake using the motion vector. With this configuration, the network camera 1000 can maintain the state of being able to effectively perform the image stabilizing control, and capturing an image with the reduced shake.

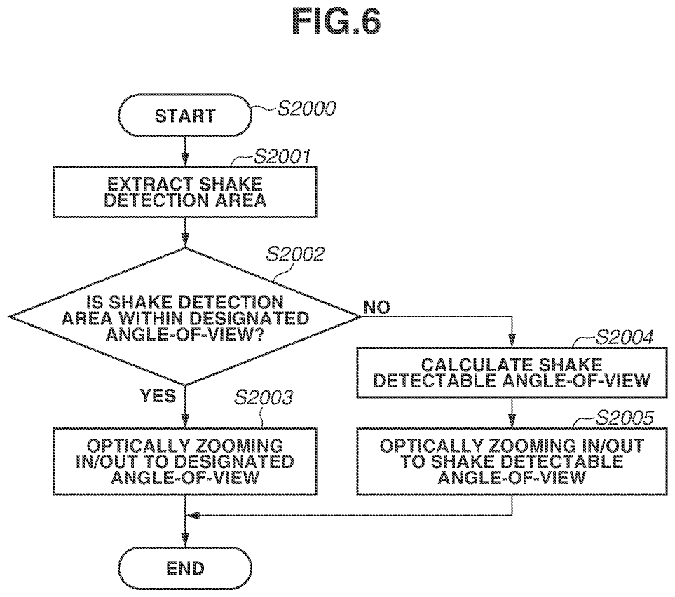

FIG. 6 is a flowchart illustrating zoom control processing of step S2000. When the network camera 1000 receives a PTZ operation instruction, the pan/tilt/zoom control unit 1008 starts to perform the zoom control processing of step S2000.

In step S2001, the pan/tilt/zoom control unit 1008 extracts a shake detection area. In extracting the shake detection area, the pan/tilt/zoom control unit 1008 extracts an area including a subject fixed and having feature points such as edges and from which the motion vector can be detected correctly. For example, the pan/tilt/zoom control unit 1008 detects, using edge detection, an area in which luminance abruptly changes in the captured image, and extracts an outline of an object in the captured image. An area surrounded by this outline is set as the shake detection area. For example, the shake detection area 2002 illustrated in FIG. 5 is extracted as the shake detection area.

In step S2002, the pan/tilt/zoom control unit 1008 determines whether the shake detection area is within the designated angle-of-view. If the shake detection area is within the designated angle-of-view (YES in step S2002), the processing proceeds to step S2003. If the shake detection area is outside the designated angle-of-view (NO in step S2002), the processing proceeds to step S2004.

In step S2003, the pan/tilt/zoom control unit 1008 optically zooms in/out to the designated angle-of-view.

In step S2004, the pan/tilt/zoom control unit 1008 calculates a shake detectable angle-of-view. In calculating the shake detectable angle-of-view, the pan/tilt/zoom control unit 1008 increases the designated angle-of-view toward the wide-angle side with respect to the center of the designated angle-of-view, and calculates the angle-of-view including the shake detection area extracted in step S2001. For example, assuming that the angle-of-view on the wide-angle end are 40 degrees horizontally and 30 degrees vertically and the center of the angle-of-view is 0 degrees, the angle-of-view including the shake detection area are represented on coordinates of −20 to +20 degrees horizontally and −15 to +15 degrees vertically. Within the angle-of-view, assume that the shake detection area has an angle-of-view of −17 to +5 degrees horizontally, and 8 to 9.5 degrees vertically. Then assume that a PTZ operation instruction of +10 degrees in the pan direction, +2 degrees in the tilt direction, and a horizontal angle-of-view of 16 degrees in the zoom direction is given. The angle-of-view when the PTZ operation is performed is, if expressed on coordinates, in a range from +2 to +18 degrees horizontally and from −4 to +8 degrees vertically, which is a range that does not include the shake detection area. From this state, the range is extended to a range including the shake detection area.

A difference between the vertical angle-of-view of 8 degrees in the range of the designated angle-of-view and the vertical angle-of-view of 9.5 degrees in the range of the shake detection area is obtained as 9.5−8=1.5 degrees. Increasing the vertical angle-of-view by 1.5 degrees in the upper and lower directions changes the vertical angle-of-view to be 15 degrees from −5.5 degrees to +9.5 degrees. At this time, the horizontal angle-of-view is obtained by the expression of 15×4/3=20 degrees. The range of the angle-of-view is changed to a range from 0 degrees to +20 degrees horizontally and −5.5 degrees to +9.5 degrees vertically, thereby achieving the angle-of-view including the shake detection area. In this manner, the shake detectable angle-of-view is calculated as 20 degrees horizontally.

While the description has been given of the example of increasing the angle-of-view toward the wide angle side with respect to the center of the designated angle-of-view, the configuration is not limited thereto. For example, shifting the center of the designated angle-of-view toward the shake detection area side can narrow a range of increasing the angle-of-view to include the shake detection area, and can thereby further decrease the utilization restriction of optical zooming.

In step S2005, the pan/tilt/zoom control unit 1008 optically zooms in/out to the shake detectable angle-of-view, and ends the processing.

As described above, in the image stabilizing control using shake detection with the motion vector, the network camera 1000 extracts the motion vector detectable area from the captured image, and obtains an optical zoom value so that the extracted area does not deviate from the angle-of-view (field of view) or the extracted area remains within the field of view. The network camera 1000 then performs zoom control using this optical zoom value, and can thereby perform control of the angle-of-view in consideration of the image stabilizing performance with any angle-of-view.

While the description has been given of the method of restricting the zoom operation to include the shake detection area in the present exemplary embodiment, the method is not limited thereto. For example, a method of digitally zooming in/out from the restricted angle-of-view in optical zooming to the designated angle-of-view may be employed. With this method, the network camera 1000 can capture an image with the designated angle-of-view while maintaining the image stabilizing performance, and decrease restriction on the designation of angle-of-view.

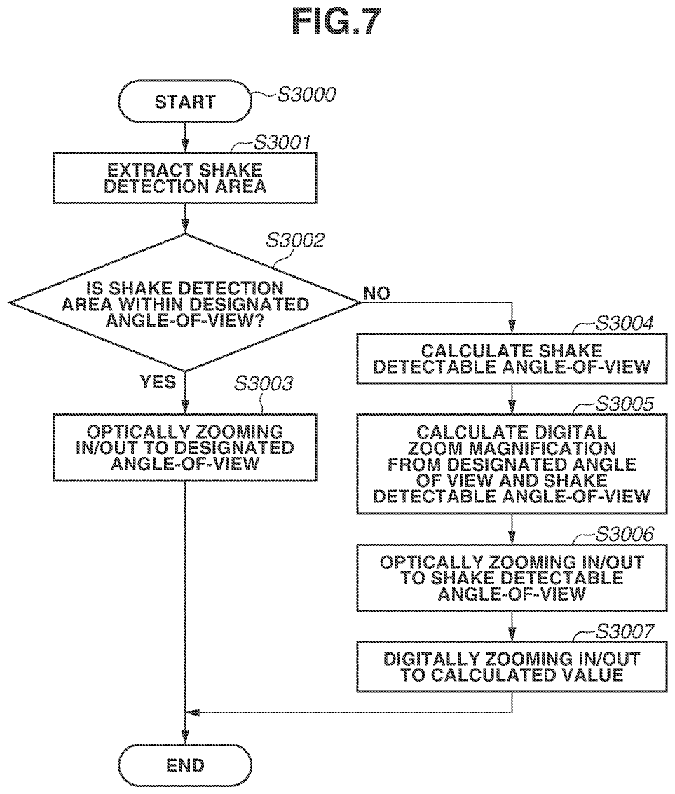

FIG. 7 is a flowchart illustrating zoom control processing in step S3000 utilizing digital zoom. When the network camera 1000 receives a PTZ operation instruction, the pan/tilt/zoom control unit 1008 starts to perform the zoom control processing in step S3000.

In step S3001, the pan/tilt/zoom control unit 1008 extracts a shake detection area using a method similar to that described above.

In step S3002, the pan/tilt/zoom control unit 1008 determines whether the shake detection angle is within the designated angle-of-view. If the shake detection area is within the designated angle-of-view (YES in step S3002), the processing proceeds to step S3003. If the shake detection area is not within the designated angle-of-view (NO in step S3002), the processing proceeds to step S3004.

In step S3003, the pan/tilt/zoom control unit 1008 optically zooms in/out to the designated angle-of-view.

In step S3004, the pan/tilt/zoom control unit 1008 calculates a shake detectable angle-of-view using a method similar to that described above.

Assume that a digital zoom magnification is 1.25, which is obtained as 20/16=1.25.

In step S3006, the pan/tilt/zoom control unit 1008 optically zooms in/out to the shake detectable angle-of-view.

In step S3007, the pan/tilt/zoom control unit 1008 digitally zooms in/out to the digital zoom magnification, and ends to processing.

While the description has been given of the method of restricting a zoom operation to include the motion vector detectable area in the present exemplary embodiment, the method is not limited thereto. For example, as a conceivable case, optical zooming is desired to be utilized while shake is permitted to some extent, depending on situations. In this case, there may be prepared a control method of restricting optical zooming while prioritizing the image stabilizing control and another control method of prioritizing the optical zooming while permitting shake, and the network camera 1000 may be capable of switching between these control methods.

While the description has been given of the method of restricting a zoom operation to include the shake detection area using the motion vector in the present exemplary embodiment, the configuration is not limited thereto. For example, the network camera 1000 can be provided with a plurality of shake detection units including a shake detection unit using a motion vector and another shake detection unit different from the shake detection unit using the motion vector, such as a gyro sensor. For example, in the angle-of-view in which shake detection using the motion vector is effective, the network camera 1000 mainly utilizes shake detected by the shake detection unit using the motion vector. In the angle-of-view in which the shake detection using the motion vector is not effective, the network camera 1000 can perform the image stabilizing control by mainly utilizing the shake detected by another shake detection unit different from the shake detection unit using the motion vector.

While the description has been given of a PT image stabilizing control unit that causes the pan/tilt driving units to perform shake correction as an image stabilizing control unit in the present exemplary embodiment, the configuration is not limited thereto. For example, the network camera 1000 may use an optical image stabilizing control unit (correcting optical system) that optically corrects shake, or an electrical image stabilizing control unit that corrects shake by segmentation of an image.

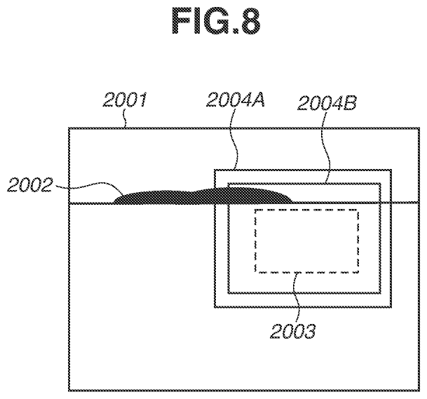

Next, a description will be given mainly of a case of taking into consideration of a magnitude of uncorrected shake that remains by the image stabilizing control according to a second exemplary embodiment, with reference to FIG. 8. Constituent elements similar to those in the first exemplary embodiment are denoted by reference numerals already used and detailed description thereof are omitted. A description will be given mainly of a difference from the first exemplary embodiment. The omission in this manner is applied to the other exemplary embodiments described below.

FIG. 8 is a diagram illustrating an example of a captured image in a case where the network camera 1000 according to the present exemplary embodiment is installed on a ship, and the magnitude of uncorrected shake that remains is different when an image is captured in the direction of the sea. FIG. 8 illustrates the image-capturing angle-of-view 2001 at the wide-angle end, the shake detection area 2002, a PTZ designated angle-of-view 2003, a shake detectable angle-of-view 2004A in a case where the magnitude of uncorrected shake that remains is large, and a shake detectable angle-of-view 2004B in a case where the magnitude of uncorrected shake that remains is small.

In FIG. 8, in a case where the designated angle-of-view 2003 is designated, the network camera 1000, instead of optically zooming in/out to the designated operation angle-of-view 2003 as described in the first exemplary embodiment, restricts optical zooming to the angle-of-view 2004A including the shake detection area 2002 on a wider-angle side than the designated angle-of-view 2003. In this way, the network camera 1000 can detect shake using the motion vector, and can thereby maintain the state of being able to effectively perform the image stabilizing control.

In the PT image stabilizing control, the network camera cannot follow the shake at a magnitude or frequency that exceeds the PT driving units, and then uncorrected shake remains. In a case where the shake detectable angle-of-view is set in a state of barely including the shake detection area on the edge, the shake detection area deviates from the shake detectable angle-of-view in a situation where uncorrected shake remains in the image stabilizing control. To address this, a setting of the shake detectable angle-of-view needs to include a margin to prevent the shake detection area from deviating from the shake detectable angle-of-view even if uncorrected shake remains. However, providing a too wide margin increases restriction on a usage range of optical zooming. For this reason, the network camera 1000 changes the shake detection area based on the magnitude of uncorrected shake that remains, and makes the shake detection area small in a case where the magnitude of uncorrected shake that remains is small. This configuration enables appropriate setting of the shake detectable angle-of-view, and can thereby decrease unnecessary restriction on the usage range of optical zooming.

Processing according to the present exemplary embodiment will be described with reference to a flowchart illustrated in FIG. 6. The description will be given mainly of processing different from that in the first exemplary embodiment, while a description of processing similar to that in the first exemplary embodiment is omitted. When the network camera 1000 receives a PTZ operation instruction, the pan/tilt/zoom control unit 1008 starts to perform the zoom control processing in step S2000.

In steps S2001 to S2003, the pan/tilt/zoom control unit 1008 performs the processing similarly to the processing described above. A margin of 0.5 degrees is obtained by 1.5−1=0.5. The pan/tilt/zoom control unit 1008 obtains 20.5 degrees as a shake detectable angle-of-view by adding the margin of 0.5 degrees to 20 degrees. In addition, if the tilt angle at which the network camera 1000 can respond to shake is 1.2 degrees under another condition, an angle of uncorrected shake that remains is calculated as 0.3 degrees by the expression of 1.5−1.2=0.3. The pan/tilt/zoom control unit 1008 obtains a shake detectable angle-of-view by adding a margin of 0.3 degrees to 20 degrees to obtain 20.3 degrees.

The pan/tilt/zoom control unit 1008 performs subsequent processing similarly to the processing described above.

As described above, in the image stabilizing control using the shake detection with the motion vector, the network camera 1000 extracts the motion vector detectable area in the captured image, and obtains an optical zoom value so that the extracted area does not deviate outside the angle-of-view depending on the magnitude of uncorrected shake that remains. The network camera 1000 performs zoom control using this optical zoom value, and can thereby perform angle-of-view control in consideration of the image stabilizing performance with any angle-of-view, and can further decrease restriction on the usage range of optical zooming.

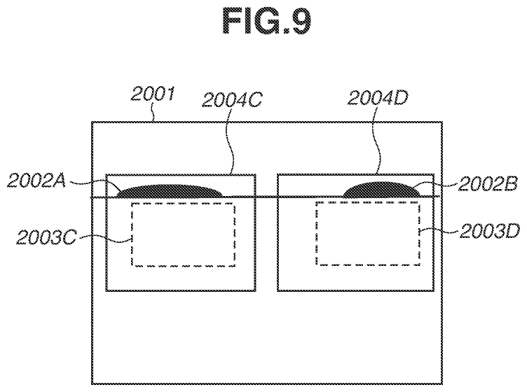

Next, a description will be given of a third exemplary embodiment, mainly of a case where there is a plurality of shake detection areas, with reference to FIG. 9. Constituent elements similar to those in the first exemplary embodiment are denoted by reference numerals already used, and detailed descriptions thereof are omitted. A description will be given mainly of a difference from the first exemplary embodiment.

FIG. 9 is a diagram illustrating an example of a captured image in a case where the network camera 1000 according to the present exemplary embodiment is installed on a ship, and there is a plurality of shake detection areas when an image of the sea direction is captured. FIG. 9 illustrates the image-capturing angle-of-view 2001 at the wide-angle end, shake detection areas 2002A and 2002B, PTZ designated angle-of-views 2003C and 2003D, a shake detectable angle-of-view 2004C in a case where the designated angle-of-view 2003C is designated, and shake detectable angle-of-view 2004D in a case where the designated angle-of-view 2003D is designated.

As illustrated in FIG. 9, the image is captured with the image-capturing angle-of-view 2001 at the wide-angle end to include the shadows of mountains at two locations on the right and left sides on the upper portion of the image. The shake detection areas 2002A and 2002B each include a subject that is fixed and that has feature points such as edges, and thus the shake detection using the motion vector can be performed therein. With the image-capturing angle-of-view 2001 at the wide-angle end, the network camera 1000 detects shake using the motion vector as described above by utilizing the shake detection areas 2002A and 2002B, and performs the image stabilizing control based on the detected shake.

In a case of setting the shake detectable angle-of-view in a situation with a plurality of shake detection areas as described above, selection of a shake detection area that is closer to the designated angle-of-view enables usage of optical zooming to angle-of-view closer to the designated angle-of-view. For example, in a case where the designated angle-of-view 2003C is designated, the network camera 1000 sets the shake detectable angle-of-view 2004C to include the shake detection area 2002A. On the other hand, in a case where the designated angle-of-view 2003D is designated, the network camera 1000 sets the shake detectable angle-of-view 2004D to include the shake detection area 2002B. This configuration can decrease restriction on the usage range of optical zooming.

Processing according to the present exemplary embodiment will be described with reference to the flowchart illustrated in FIG. 6. The description will be given mainly of processing different from that in the first exemplary embodiment, while a description of processing similar to that in the first exemplary embodiment is omitted. When zooming is designated to the network camera 1000, the pan/tilt/zoom control unit 1008 starts to perform processing in step S2000.

In step S2001, the pan/tilt/zoom control unit 1008 extracts a shake detection area. In a method similar to the method described above, the pan/tilt/zoom control unit 1008 extracts the two shake detection areas 2002A and 2002B illustrated in FIG. 9 in this example.

Subsequently, in steps S2002 and S2003, the pan/tilt/zoom control unit 1008 performs processing similarly to that described above.

In step S2004, the pan/tilt/zoom control unit 1008 calculates a shake detectable angle-of-view. The pan/tilt/zoom control unit 1008 compares the extracted shake detection areas 2002A and 2002B at two locations and the designated angle-of-view, and selects the one closer to the designated angle-of-view.

For example, assuming that the angle-of-view on the wide-angle end is 40 degrees horizontally and 30 degrees vertically, and the center of the angle-of-view is 0 degrees, the shake detection areas are represented on coordinates of −20 to +20 degrees horizontally and −15 to +15 degrees vertically. Assume that one of the two shake detection areas is in a range from −17 to −7 degrees horizontally and from 8 to 9.5 degrees vertically, and the other of the two shake detection areas is in a range from 10 to 15 degrees horizontally and from 8 to 9.5 degrees vertically. Then assume that an instruction of the PTZ operation of +10 degrees in the pan direction, +2 degrees in the tilt direction, and a horizontal angle-of-view of 16 degrees in the zoom direction is given. The angle-of-view when the PTZ operation is performed is, if expressed on coordinates, in a range from +2 to +18 degrees horizontally and from −4 to +8 degrees vertically, which is a range that does not include the shake detection area.

The centroid coordinates of the designated angle-of-view are as follows.
10 degrees horizontally obtained by (18−2)/2+2=10
2 degrees vertically obtained by (8−(−4))/2−4=2

The centroid coordinates of the shake detection area 2002A are as follows.
−12 degrees horizontally obtained by (−7−(−17))/2−17=−12
8.75 degrees vertically obtained by (9.5−8)/2+8=8.75

The centroid coordinates of the shake detection area 2002B are as follows.
12.5 degrees horizontally obtained by (15−10)/2+10=12.5
8.75 degrees vertically obtained by (9.5−8)/2+8=8.75

A distance between the centroid of the designated angle-of-view and the centroid of the shake detection area 2002A is obtained by the following Equation (1).

{square root over ((10−(−12))²+(2−8.75)²)}≈23 [Equation (1)]

On the other hand, a distance between the centroid of the designated angle-of-view and the centroid of the shake detection area 2002B is obtained by the following Equation (2).

\sqrt{(10−12.5)²+(2−8.75)²}≈7 [Equation (2)]

The pan/tilt/zoom control unit 1008 compares the obtained distances from the corresponding designated angle-of-view, and selects the shake detection area 2002B as the shake detection area because the shake detection area 2002B is closer to the designated angle-of-view.

The pan/tilt/zoom control unit 1008 calculates the shake detectable angle-of-view with respect to the designated angle-of-view to include the selected shake detection area 2002B similarly to the processing described above. The pan/tilt/zoom control unit 1008 performs subsequent processing similarly to the processing described above.

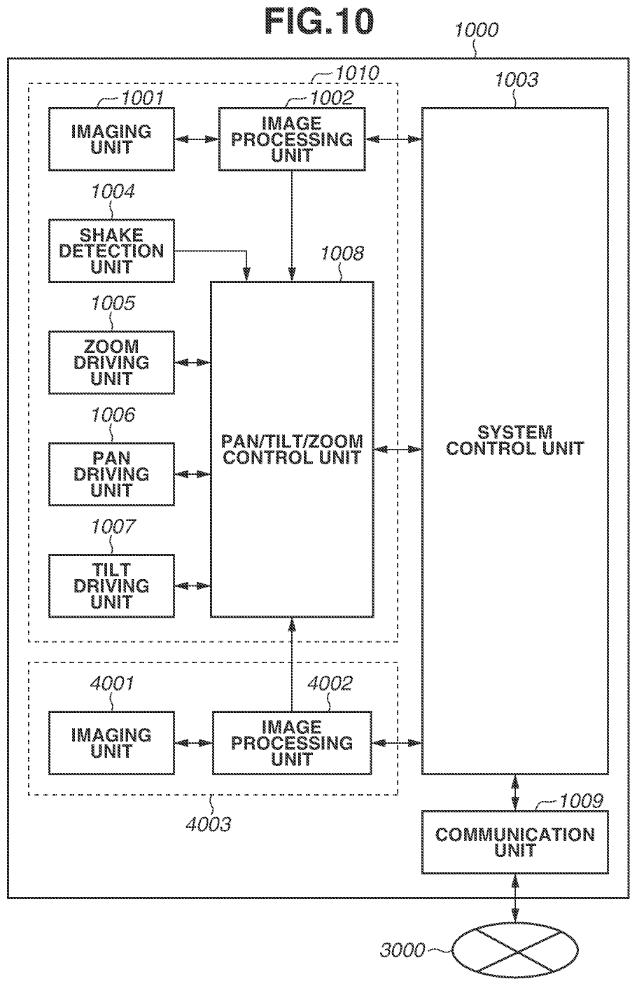

Next, a description will be given of a fourth exemplary embodiment with reference to FIG. 10, mainly of a configuration of performing shake detection and pan/tilt/zoom operations with another lens barrel. Constituent elements similar to those in the first exemplary embodiment are denoted by reference numerals already used and detailed description thereof are omitted. A description will be given mainly of a difference from the first exemplary embodiment.

FIG. 10 is a functional block diagram of the network camera 1000 according to the present exemplary embodiment. The network camera 1000 is communicably connected to the client apparatus (information processing apparatus), which is not illustrated, via the network 3000.

A description is now given of a configuration and function of each unit of the network camera 1000 with reference to FIG. 10.

The network camera 1000 includes a first lens barrel unit 1010, and a second lens barrel unit 4003. The first lens barrel unit 1010, similarly to the configuration described in the first exemplary embodiment, includes a first imaging unit 1001, a first image processing unit 1002, the shake detection unit 1004, the zoom driving unit 1005, the pan driving unit 1006, the tilt driving unit 1007, and the pan/tilt/zoom control unit 1008. The second lens barrel unit 4003 includes a second imaging unit 4001 and a second image processing unit 4002. The network camera 1000 is composed of the system control unit 1003 and the communication unit 1009 in addition to the first lens barrel unit 1010 and the second lens barrel unit 4003.

The first lens barrel unit 1010 is capable of changing the angle-of-view by performing pan/tilt/zoom operations, and performing the image stabilizing control by the pan driving unit 1006 and the tilt driving unit 1007, as described in the first exemplary embodiment. In the present exemplary embodiment, however, the first image processing unit 1002 does not perform shake detection processing on an image using the motion vector.

The second imaging unit 4001 includes lenses, an image sensor, and a control group for the lenses and the image sensors, captures an image of a subject, and converts the image to electric signals. The second imaging unit 4001 includes a lens capable of taking an image with wide angle-of-view. The second image processing unit 4002 performs predetermined development processing and compression coding processing on signals obtained by photoelectrically converting an image captured by the second imaging unit 4001, generates image data, and transmits the image data to the system control unit 1003. In addition, the second image processing unit 4002 performs processing of analyzing the image captured by the second imaging unit 4001 and detecting shake of the image using the motion vector. Information of the shake is transmitted to the pan/tilt/zoom control unit 1008, and used for the image stabilizing control, which will be described below.

The system control unit 1003 transmits the image data generated by the first image processing unit 1002 and image data generated by the second image processing unit 4002 to the client apparatus via the communication unit 1009.

The communication unit 1009 receives respective camera control commands for the first lens barrel unit 1010 and the second lens barrel unit 4003 transmitted from the client apparatus, and transmits the camera control commands to the system control unit 1003. In addition, the communication unit 1009 transmits, to the client apparatus, responses to the camera control commands The system control unit 1003 analyzes the transmitted camera control commands, and performs processing corresponding to the commands For example, the system control unit 1003 transmits an instruction for setting image quality to the first image processing unit 1002 or the second image processing unit 4002. The first image processing unit 1002 and the second image processing unit 4002 each perform image processing based on the transmitted instruction.

In this manner, the network camera (imaging apparatus) 1000 according to the present exemplary embodiment includes the two lens barrel units, i.e., the first lens barrel unit capable of changing the angle-of-view by performing pan/tilt/zoom operations and performing the image stabilizing control by the pan/tilt driving units, and the second lens barrel unit that is different from the first lens barrel unit and that is capable of capturing an image with a wide angle-of-view. The network camera 1000 then performs the shake detection processing using the motion vector on an image captured by the second lens barrel unit with a wide angle-of-view, and causes the first lens barrel unit to perform the image stabilizing control using the shake detected in the second lens barrel unit. This configuration can eliminate restrictions on the usage range of optical zooming.

Processing according to the present exemplary embodiment will be described using the flowchart illustrated in FIG. 4. The description will be given mainly of processing different from that in the first exemplary embodiment, while a description of processing similar to that in the first exemplary embodiment is omitted. When the network camera 1000 starts to capture an image, the pan/tilt/zoom control unit 1008 starts to perform zoom control processing in step S1000.

In steps S1001 to S1002, the pan/tilt/zoom control unit 1008 performs processing similarly to the processing described above.

In step S1003, the second image processing unit 4002 obtains a motion vector similarly to the processing described above. The pan/tilt/zoom control unit 1008 acquires the motion vector obtained by the second image processing unit 4002.

In steps S1004 to S1006, the pan/tilt/zoom control unit 1008 performs the processing similarly to the processing described above.

In this manner, the network camera 1000 controls the pan/tilt driving units to cancel the shake based on the magnitude of shake detected in each of the pan direction and the tilt direction, and reduces the shake.

As described above, the network camera 1000 performs the shake detection processing using the motion vector on an image captured with a wide angle-of-view by the second lens barrel unit. The network camera 1000 then causes the first lens barrel unit to perform the image stabilizing control using the shake detected by the second lens barrel unit. With this configuration, the network camera 1000 can maintain the image stabilizing performance with any angle-of-view, and furthermore, can eliminate the restrictions on the usage range of optical zooming.

While the description has been given of the configuration of the network camera 1000 including the two lens barrel units, i.e., the first lens barrel unit 1010 capable of changing the angle-of-view by performing pan/tilt/zoom operations and performing the image stabilizing control by the pan/tilt driving units, and the second lens barrel unit 4003 different from the first lens barrel unit 1010, the configuration is not limited thereto. For example, a second imaging apparatus constantly performs the image stabilizing control using the motion vector on an image captured with a wide angle-of-view and transmits information of detected shake to a first imaging apparatus, and the first imaging apparatus performs the image stabilizing control using the transmitted information of the shake.

### Other Exemplary Embodiment

A program (software) that implements functions of the exemplary embodiments described above to perform part of or all of the control may be supplied to an imaging apparatus or an information processing apparatus via a network or a storage medium of various types. A computer (or a central processing unit (CPU), a microprocessing unit (MPU), or the like) in the imaging apparatus or the information processing apparatus, or the system control unit 1003 may read out and execute the program. In this case, the program and the storage medium storing the program constitute the disclosure.

While the exemplary embodiments have been described, the disclosure is not limited to these exemplary embodiments, and various modifications and changes can be made without departing from the gist of the disclosure.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-115057, filed Jul. 2, 2020, which is hereby incorporated by reference herein in its entirety.

What is claimed is:

1. An imaging apparatus comprising:
an imaging unit configured to capture an image formed by an imaging optical system;
a zoom driving unit configured to change an angle-of-view of the imaging optical system;
an extraction unit configured to extract an area in which a motion vector can be detected in the image captured by the imaging unit;
a shake detection unit configured to detect an amount of shake of the image based on the motion vector in the area extracted by the extraction unit;
a shake correcting unit configured to correct shake of the image based on the amount of shake detected by the shake detection unit; and
a control unit configured to control the zoom driving unit to prevent the area extracted by the extraction unit from deviating from a field of view of the imaging optical system.

2. The imaging apparatus according to claim 1, further comprising:
a pan driving unit configured to drive the imaging optical system in a pan direction; and
a tilt driving unit configured to drive the imaging optical system in a tilt direction,
wherein the shake correcting unit is configured to correct shake of the image by driving the imaging optical system using at least one of the pan driving unit and the tilt driving unit based on the amount of shake detected by the shake detection unit.

3. The imaging apparatus according to claim 1,
wherein the imaging optical system includes a shake correcting optical system, and
wherein the shake correcting unit is configured to correct shake of the image by controlling driving of the shake correcting optical system based on the amount of shake detected by the shake detection unit.

4. The imaging apparatus according to claim 1,
wherein the shake correcting unit is configured to correct shake of the image by clipping a range corresponding to the amount of shake detected by the shake detection unit from the image captured by the imaging unit.

5. The imaging apparatus according to claim 1,
wherein the control unit is configured to, in a case where the area extracted by the extraction unit deviates from the field of view of the imaging optical system when optical zooming is performed by the zoom driving unit, control the imaging unit to perform digital zoom.

6. The imaging apparatus according to claim 1,
wherein the control unit is configured to control the zoom driving unit based on a difference between the amount of shake detected by the shake detection unit and an amount of the correction made by the shake correcting unit.

7. The imaging apparatus according to claim 1, further comprising an acceptance unit configured to accept designation of an imaging range,
wherein the control unit is configured to control the zoom driving unit so that an area close to the imaging range, the designation of which is accepted by the acceptance unit, out of a plurality of areas extracted by the extraction unit, is included in the field of view of the imaging optical system.

8. A method of controlling an imaging apparatus, the method comprising:
capturing an image formed by an imaging optical system;
extracting an area in which a motion vector can be detected in the captured image;
detecting an amount of shake of the image based on a motion vector in the extracted area;
correcting shake of the image based on the detected amount of shake; and
controlling optical zooming of the imaging optical system to prevent the extracted area from deviating from a field of view of the imaging optical system.

9. The method according to claim 8, further comprising:
driving the imaging optical system in a pan direction; and
driving the imaging optical system in a tilt direction,
wherein the correcting includes correcting shake of the image by driving the imaging optical system using at least one of the driving in the pan direction and the driving in the tilt direction based on the detected amount of shake.

10. The method according to claim 8,
wherein the correcting includes correcting the shake of the image by controlling driving of a shake correcting optical system of the imaging optical system based on the detected amount of shake.

11. The method according to claim 8,
wherein the correcting includes correcting the shake of the image by slipping from the captured image a range based on the detected amount of shake.

12. The method according to claim 8,
wherein, in a case where the extracted area deviates from the field of view of the imaging optical system when performing the optical zooming, the controlling includes controlling the capturing of the image to perform digital zooming.

13. The method according to claim 8,
wherein the controlling includes controlling the optical zooming based on a difference between the detected amount of shake and an amount of the corrected shake.

14. The method according to claim 8, further comprising accepting designation of an imaging range,
wherein the controlling includes controlling the optical zooming so that an area closer to the imaging range, the designation of which is accepted, out of a plurality of extracted areas, is included in the field of view of the imaging optical system.

15. A non-transitory computer-readable medium storing a program for causing a computer to execute an image processing method, the method comprising:
capturing an image formed by an imaging optical system;
extracting an area in which a motion vector can be detected in the captured image;
detecting an amount of shake of the image based on the motion vector in the extracted area;
correcting shake of the image based on the detected amount of shake; and
controlling optical zooming of the imaging optical system to prevent the extracted area from deviating from a field of view of the imaging optical system.
